(19) United States
(12) Patent Application Publication
(10) Pub. No.: US 2012/0192060 A1
(43) Pub. Date: Jul. 26, 2012

(54) SYSTEM AND METHOD FOR UPDATING HTML DOCUMENTS IN AN HTML DOCUMENT UPDATING DEVICE

(75) Inventors: SHIH-FANG WONG, Tu-Cheng (TW); XIN LU, Shenzhen (CN); YAO-HUA LIU, Shenzhen (CN); YUN-YAN WU, Shenzhen (CN); XI LIN, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/076,463

(22) Filed: Mar. 31, 2011

(30) Foreign Application Priority Data
Jan. 21, 2011 (CN) 201110023799.2

(51) Int. Cl. G06F 17/00

(52) U.S. Cl. 715/234

(57) ABSTRACT

An HTML document updating method implement for an HTML document updating device is provided. The device includes a storage system to store at least one HTML document of a given webpage. The method includes: first saving an input given website address as a URL of a webpage. Then, obtaining a HTML document of the given webpage at every time interval. Next, analyzing the currently obtained HTML document and a saved HTML document, obtaining HTML elements of the currently obtained HTML document and the HTML elements of the saved HTML document, and updating the HTML element of the saved HTML document of the given webpage with the corresponding HTML element of the currently obtained HTML document of the given webpage when the HTML element of the saved HTML document of the given webpage does not match the corresponding HTML element of the currently obtained HTML document of the given webpage.

### BACKGROUND

1. Technical Field

The present disclosure relates to HTML document devices and, particularly, to a system and method for updating HTML documents in an HTML document updating device.

2. Description of Related Art

Some special system programs such as spider programs are embedded in some webpages and can obtain content of other webpages, thus users can get information from other webpages with similar content. However, the usual special system cannot timely update the obtained content of the other webpages, thus users may not get the latest information from the other webpages.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an HTML document updating device in accordance with an exemplary embodiment.

FIG. 2 is a flowchart of an updating method in accordance with an exemplary embodiment.

### DETAILED DESCRIPTION

Embodiments of the present disclosure are now described in detail, with reference to the accompanying drawings.

In general, the word “module,” as used herein, refers to logic embodied in hardware or firmware, or to a collection of software instructions, written in a programming language, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

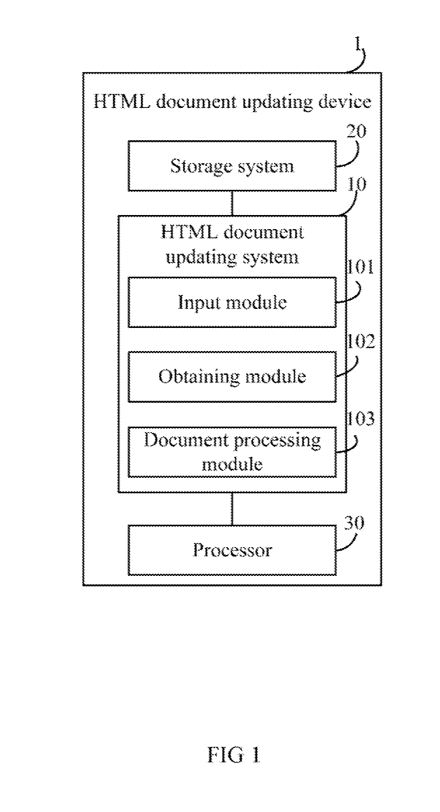

Referring to FIG. 1, an HTML document updating device 1 (hereinafter, the device 1) in accordance with an exemplary embodiment is shown. The device 1 includes an HTML document updating system 10 (hereinafter, the updating system 10), a storage system 20, and a processor 30. The storage system 20 is configured to store at least one HTML document of a given webpage. The storage system 20 may be a memory system of the saving device 1, and may be an external storage card, such as a smart media (SM) card, or secure digital (SD) card, for example. The processor 30 executes one or more computerized codes of the device 1 and other applications, to provide the functions of the device 1. The updating system 10 is a program code embedded in a source code of a webpage. The updating system 10 periodically obtains content of the given webpage. The updating system 10 includes an input module 101, an obtaining module 102, and a document processing module 103. The modules 101-103 may comprise computerized code in the form of one or more programs that are stored in the storage system 20. The computerized code includes instructions that are executed by the at least one processor 30 to provide functions for modules 101-103. Details of these operations are as follows.

The input module 101 provides a user interface for a user to input information. In this embodiment, a given website address is input and saved as a URL (Uniform/Universal Resource Locator, URL) of the webpage in response to user inputs.

The obtaining module 102 obtains an HTML document of the given webpage according to the given website address of the URL every a time interval. In detail, the obtaining module 102 employs the web Browser to retrieve the HTML document of the given webpage. Once the HTML document has been retrieved, the web Browser will display the webpage to the user. In the embodiment, the time interval is a default value or set by the user through the user interface provided by the input module 101.

The document processing module 103 determines whether there is a saved HTML document of the given webpage when the obtaining module 102 is to obtain the HTML document of the webpage. If there is no saved HTML document, the document processing module 103 saves the currently obtained HTML document of the given webpage (hereinafter, currently obtained HTML document).

If there is a saved HTML document of the given webpage, the document processing module 103 analyzes the saved HTML document of the given webpage (hereinafter, saved HTML document) and the current obtained HTML document to obtain the HTML elements of the saved HTML document and the currently obtained HTML document. The document processing module 103 compares each HTML element of the saved document with the corresponding HTML element of the currently obtained HTML document. If there is no match, the document processing module 103 updates the HTML element of the saved HTML document with the corresponding HTML element of the currently obtained HTML document. If there is a match, the document processing module 103 does not update the saved HTML document. In the embodiment, the HTML elements may include button ActiveXs, or table ActiveXs. The document processing module 103 analyzes the HTML documents and obtains the HTML elements through document.getElementById, which is a function of JavaScript language and the description of which is omitted herein.

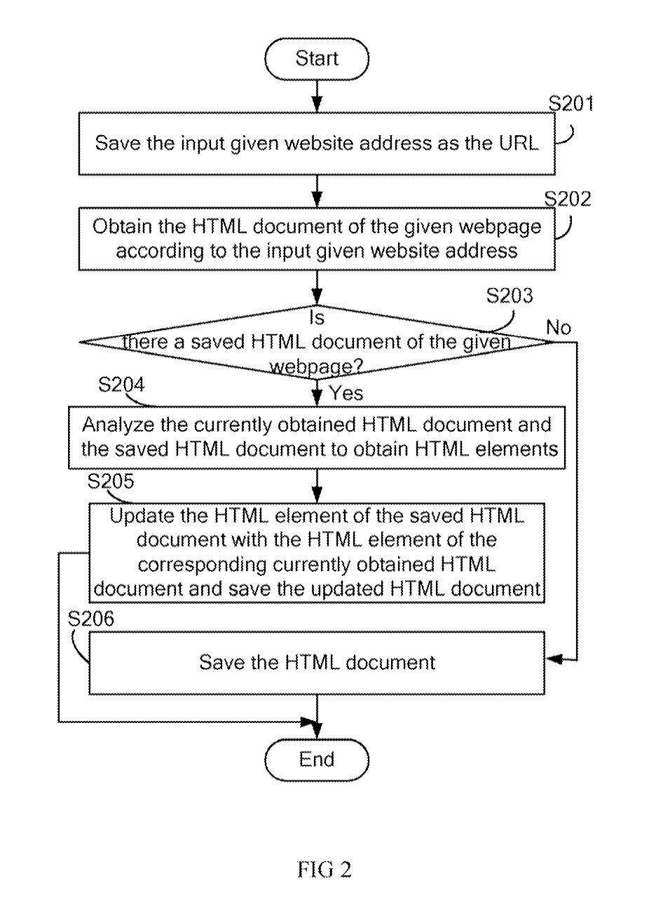

Referring to FIG. 2, a method of updating the information of a given webpage is shown.

In step S201, the input module 101 provides a user interface for a user to input a given website address, and save the input given website address as a URL of the webpage in response to the user inputs.

In step S202, the obtaining module 102 obtains the HTML document of the given webpage according to the input given website address of the URL every a time interval.

In step S203, the document processing module 103 determines whether there is a saved HTML document of the given webpage. If there is a saved HTML document of the given webpage, the procedure goes to S204. If there is no saved HTML document of the given webpage, the procedure goes to S206.

In step S204, the document processing module 103 analyzes the currently obtained HTML document and the saved HTML document to obtain the HTML elements of the current HTML document and the HTML elements of the saved HTML document.

In step S205, the document processing module 103 updates the HTML element of the saved HTML document with the corresponding HTML element of the currently obtained HTML document and saves the updated HTML element when the HTML element of the saved document does not match the corresponding HTML element of the currently obtained HTML document.

In step S206, the document processing module 103 saves the currently obtained HTML document.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An HTML document updating system comprising:
a storage system to store at least one HTML document of a given webpage;
at least one processor; and
one or more programs stored in the storage system, executable by the at least one processor, the one or more programs comprising:
an input module operable to save an input website address as a URL of a webpage;
an obtaining module operable to obtain an HTML document of a given webpage according to the input website address of the URL every a time interval; and
a document processing module operable to analyze the currently obtained HTML document of the given webpage and a saved HTML document of the given webpage if the saved HTML document of the given webpage exists, obtain the HTML elements of the currently obtained HTML document of the given webpage and the saved HTML document of the given webpage, update the HTML element of the saved HTML document with the corresponding HTML element of the currently obtained HTML document when the HTML element of the saved HTML document does not match the HTML element of the currently obtained HTML document.

2. The HTML document updating system as described in claim 1, wherein the document processing module is further operable to save the updated HTML element.

3. The HTML document updating system as described in claim 1, wherein the document processing module is further operable to save the currently obtained HTML document of the given webpage if there is not saved HTML document.

4. The HTML document updating system as described in claim 1, wherein the obtaining module employs a web Browser to retrieve the HTML document of the given webpage.

5. The HTML document updating system as described in claim 1, wherein the document processing module obtains the HTML elements of the currently obtained HTML document and the HTML elements of the saved HTML document through document.getElementById.

6. The HTML document updating system as described in claim 1, wherein the function modules are program codes and are embedded in a source code of a webpage.

7. The HTML document updating system as described in claim 1, wherein the time interval is a default value.

8. The HTML document updating system as described in claim 1, wherein the timed interval is set by the user through a user interface provided by the input module.

9. An HTML document updating method in an HTML document updating device, the HTML document updating device comprising a storage system to store at least one HTML document of a given webpage, the method comprising:
saving an input given website address as a URL of a webpage in response to user inputs;
obtaining the HTML document of the given webpage according to the input given website address of the URL every a time interval; and
analyzing the currently obtained HTML document of the given webpage and the saved HTML document of the given webpage if there is a saved HTML document of the given webpage, obtaining HTML elements of the currently obtained HTML document and the HTML elements of the saved HTML document, and updating the HTML element of the saved HTML document of the given webpage with the corresponding HTML element of the currently obtained HTML document of the given webpage when the HTML element of the saved HTML document of the given webpage does not match the corresponding HTML element of the currently obtained HTML document of the given webpage.

10. The HTML document updating method as described in claim 9, further comprising:
saving the updated HTML element.

11. The HTML document updating method as described in claim 9, further comprising:
saving the currently obtained HTML document of the given webpage if there is no saved HTML document of the given webpage.

12. The HTML document updating method as described in claim 9, wherein the step of obtaining the HTML document of the given webpage is obtaining the HTML documents of the given webpage through a web Browser.

13. The HTML document updating method as described in claim 9, wherein the step of obtaining the HTML elements of the currently obtained HTML document and the HTML elements of the saved HTML document is obtaining the HTML elements of the currently obtained HTML document and the HTML elements of the saved HTML document through document.getElementById.

14. The HTML document updating method as described in claim 9, wherein the time interval is a default value.

15. A storage system storing a set of instructions, the set of instructions capable of executed by a processor to perform a saving method in a HTML document updating device, the method comprising:
saving an input given website address as a URL of a webpage in response to user inputs;
obtaining the HTML document of the given webpage according to the input given website address of the URL every a time interval; and
analyzing the currently obtained HTML document of the given webpage and the saved HTML document of the given webpage if there is a saved HTML document of the given webpage, obtaining HTML elements of the currently obtained HTML document and the HTML elements of the saved HTML document, and updating the HTML element of the saved HTML document of the given webpage with the corresponding HTML element of the currently obtained HTML document of the given webpage when the HTML element of the saved HTML document of the given webpage does not match the corresponding HTML element of the currently obtained HTML document of the given webpage.

16. The storage system as described in claim 15, further comprising saving the updated HTML element.

17. The storage system as described in claim 15, further comprising saving the currently obtained HTML document of the given webpage if there is no saved HTML document of the given webpage.
